(19) United States
(12) Patent Application Publication
(10) Pub. No.: US 2011/0244086 A1
(43) Pub. Date: Oct. 6, 2011

(54) Edible Food Transport Base System and Method of Use Thereof

(76) Inventor: Janet Vale Heath, Tulare, CA (US)

(21) Appl. No.: 13/020,781

(22) Filed: Feb. 3, 2011

Related U.S. Application Data
(60) Provisional application No. 61/337,441, filed on Feb. 4, 2010.

(51) Int. Cl. A23P 1/08

(52) U.S. Cl. 426/138; 426/272

(57) ABSTRACT

A food transport system and edible food transfer base for producing a completed food product. The food transfer base allows a food preparer to easily, efficiently and quickly transfer one or more augmenting ingredients to one or more recipient ingredients so as to augment, change and improve the taste, aroma, appearance and character of the recipient ingredients and produce the completed food product. The food transfer base is made from a material that can be substantially tasteless or add to the taste of the completed food product, but which will be integrated into the recipient ingredients and/or the augmenting ingredients. A transformative step, which is provided by the recipient ingredients and/or an external source, applies heat, cold, liquid, steam, gas or other process to the food transfer base and augmenting ingredients to produce the completed food product and substantially change the character and/or consistency of the food transfer base.

### CROSS-REFERENCE TO RELATED APPLICATIONS

This patent application claims the benefit of U.S. Provisional Patent Application No. 61/337,441 filed Feb. 4, 2010.

### STATEMENT REGARDING FEDERALLY SPONSORED RESEARCH

Not Applicable.

### REFERENCE TO A SEQUENCE LISTING, A TABLE OR A COMPUTER PROGRAM LISTING APPENDIX SUBMITTED ON A COMPACT DISC

Not Applicable.

### BACKGROUND OF THE INVENTION

A. Field of the Invention

The field of the present invention relates generally to devices, systems and methods for preparing food products. In particular, the present invention relates to devices, systems and methods allowing a food preparer to easily transfer one set of ingredients to another set of ingredients to produce a completed food product. Even more particularly, this invention relates to such devices, systems and methods that allow the food preparer to prepare topping or other augmenting ingredients on an edible food transfer base and then transfer those ingredients on the transfer base to one or more recipient ingredients to produce the completed food product.

B. Background

All food products that are prepared for consumption by one or more persons initially require collecting and then mixing, arranging or other combining of the various ingredients that make up the finished or completed food product. This collecting and then combining of the ingredients is applicable to all types and forms of completed food products, whether the food product is prepared at home, in a restaurant, by a “street” food vendor or by companies that sell food products at supermarkets and other locations that then require final preparation, such as cooking in a microwave or oven, by the consumer at his or her home. The type and amount of collecting and combining of ingredients to prepare a completed food product various substantially by the food product. Some food products can be prepared with a minimal amount of collecting and combining of ingredients, typically because the ingredients are few and/or are readily available to the food preparer, while preparation of other food products require substantial effort to collect and combine the ingredients. To assist the food preparer with the process of collecting and combining ingredients, many commonly utilized ingredients are available in a single package that has the ingredients pre-combined. Examples of such previously collected and combined ingredients that are utilized to prepare final food products include packages of different cheeses that are pre-mixed and pre-shredded, boxes of baking mix such as Bisquick® or the like, jars of sauces for pizza, spaghetti and the like and bottles of combined spices. As well known in the art, there are many other types of pre-combined ingredients in addition to the previously listed examples that can be utilized to prepare food products.

In this age of where it seems everyone is always in a hurry and have somewhat little time to prepare food products that require any significant amount of collecting and combining of ingredients, many people desire food products that are previously prepared and either are ready to eat (i.e., fast food) or only require heating to eat. This desire has led to a significant increase in fast food outlets, grocery stores that sell cooked food and availability of canned and frozen foods. Unfortunately, many of these food sources, particularly the fast food outlets, tend to provide food products that are not as healthy as fresh-prepared food products and, in most instances, are not as tasty. In addition, the variety of food products that are available on a “fast food” basis is somewhat limited. While many canned, frozen and other packaged food products can be more healthy and fresher due to being prepared at home, depending on the individual food product, the available variety of such food products is also somewhat limited. To overcome the limited nature of these packaged food products, make the food products more interesting to those who will be eating the food products and, in some cases, to improve the healthiness of the packaged food products, some food preparers will add their own ingredients (such as fresh vegetables or fruit, meat or cheese) to the food product. To do so, however, does require more collecting and combining effort on the part of the food preparer, which reduces the time-reducing benefit of selecting prepared food products. As an example, frozen and other store-bought pizzas are commonly available in only a few varieties, such as cheese, pepperoni and combination. If someone desires a different variety of pizza, such as a mushroom and olive pizza, he or she will typically purchase the plain cheese pizza and then add the mushrooms and olives on top of the cheese. While this does produce a mushroom and olive pizza, it does require the food preparer to collect and, typically, slice up the mushrooms and olives and place them on top of the cheese pizza. In addition, the pizza will likely not taste as good as a similarly configured pizza that was prepared with all of the toppings placed on and cooked together. Other types of packaged food products can be modified by the food preparer in various food-appropriate ways.

When making a food product that is beyond a basic or simple food product, most food preparers follow a recipe that instructs the food preparer on what ingredients are required, how the ingredients are prepared and mixed and how and how long the combined ingredients are cooked to achieve the desired completed food product. Some of these recipes, which are commonly obtained or available through cookbooks, the Internet, friends, family or other sources, are well known to most food preparers. Other recipes are not commonly known or available, having been passed down in a family through generations or otherwise available only to the food preparer and, perhaps, a few others. Some people use these recipes to prepare food products for sale, either directly to the consumer or at their or their employer's eating establishment. As a result of the quality of the food preparer and/or his or her recipe, some of these food preparers and their food products have become well known locally, nationally or even internationally. Due to their frame, many consumers desire to eat food that is prepared by the famous food preparer or food that is at least prepared according to that person's recipes. Eating food freshly prepared by a food preparer requires the consumer to go to the restaurant or other location where the food preparer is preparing the food, which is often difficult to do if the food preparer lives in a different part of the country or even in a different country. While some food products prepared by famous chefs utilizing their famous recipes are adaptable to being available as a canned, frozen or other packaged food product, most of these food prepares are not able to take advantage of this market and/or do not desire to sell packaged food products due to the fact that many ingredients do not package very well.

What is needed is an improved device and system for and method of preparing a completed food product that allows the food preparer to prepare in advance a portion of the ingredients for the food product or to utilize ingredients that were prepared in advance by others to relatively quickly and easily prepare the completed food product. Such a device should be configured to allow the food preparer to transfer one or more ingredients to one or more other ingredients to enhance or otherwise augment the second set of ingredients so as to result in the completed food product. Preferably, the device should be comprised of food or food-related products that allows the food preparer to transfer ingredients to a second set of ingredients in a manner that alters the character of the second set of ingredients and results in preparation of the completed food product without the device adding any unintended flavor of its own to the completed food product. The device should be able to be configured as stiff or flexible food transfer base that supports one or more ingredients thereon so it may be placed on or wrapped around one or more second ingredients to prepare the completed food product. Preferably, the device and system for and method of preparing a completed food product should be adaptable to a wide range of ingredients and food products.

### SUMMARY OF THE INVENTION

The edible food transfer base system and method of the present invention provides the benefits and solves the problems identified above. That is to say, the present invention discloses a device which is utilized as an edible food transport base to allow a food preparer to quickly and easily transfer one or more ingredients disposed on the device to one or more second ingredients so as to augment and modify the second ingredient(s) with the transferred ingredient(s) in a manner that results in the completed food product. In a preferred embodiment, the food transfer base is made out of a food-based material that is selected so as to be able to transfer the augmenting ingredients to the recipient ingredients without adding any or very little unintended flavor of its own to the recipient ingredients. Preferably, the food transfer base can be configured as a relatively rigid base for placement on or in the recipient ingredient or sufficiently flexible so it may be wrapped around the recipient ingredient. The food transfer base is adaptable for transferring a wide variety of augmenting ingredients to a wide variety of recipient ingredients. In one embodiment, ingredients from a famous recipe and/or famous chef can be placed on the food transfer base to allow other persons to prepare the completed food product having the taste and other food characteristics of the famous food product.

In a primary embodiment of the present invention, the food transfer base generally comprises a base body having an upper surface and a lower surface. The base body is made from an edible material that is not selected to be eaten alone, the upper surface is provided to receive one or more augmenting ingredients thereon and the lower surface is placed on, in or around one or more recipient ingredients. Alternatively, augmenting ingredients can be incorporated into the base body of the food transfer base. The food transfer base and the augmenting ingredients thereon or therein define an augmented base that, like the food transfer base, is not selected to be eaten alone. The augmented base is placed in contact with the recipient ingredients. The edible material for the base body is selected so as to be integrated into at least one of the augmenting ingredients and the recipient ingredients upon the augmented base being placed in contact with the recipient ingredients or upon the application of an external transformative step, either of which produces a completed food product. An external transformative step can include the application of heat, cold, liquid, steam, gas or other processes which is applied from an external source, such as an oven, microwave oven, stove, freezer, refrigerator, water bottle or the like. Contact with the recipient ingredients and/or the application of an external transformative step substantially changes the character and/or consistency of the food transfer base and changes the character and/or consistency of the recipient ingredients. The food transfer base can be stiff or rigid, configured to be cuttable, breakable, crushable, moldable or otherwise adaptable to being portion controlled or be flexible so it can be wrapped around the recipient ingredient. In one embodiment, the base body is made from or comprises tapioca, milk, rice, corn starch, sugar and/or guar gum, either singularly or in various combinations thereof. Alternatively, the food transfer base can be made from virtually any type of food or food-related product. For instance, the food transfer base can be made from cheese, soya, sugar, pulverized olives, dried mashed potatoes, frozen peanut butter, egg whites, tomato paste and the like. The material for the food transfer base is selected so as to substantially dissolve into transparency, liquify, coagulate, gum, thicken, melt, crisp, toast, brown, crumble, effervesce, bubble or pop upon application of the transformative step to substantially change the character of the augmenting and recipient ingredients into the desired completed food product.

The system for producing a completed food product generally comprises the above-described food transfer base, one or more augmenting ingredients received on the upper surface of the base body or in the base body of the food transfer base and one or more recipient ingredients. The combination of augmenting ingredients and the food transfer base define an augmented base. The augmented base are placed on, in or around the recipient ingredients to define an assembled food product. The edible material of the food transfer base is selected so that the food transfer base will be integrated into at least one of the augmenting ingredients and the recipient ingredients upon contact with the recipient ingredient and/or application of an external transformative step to the assembled food product. The system will produce the completed food product and substantially change the character and/or consistency of the food transfer base and the character and/or consistency of the recipient ingredients.

The method of producing a completed food product generally comprises the steps of (a) providing a food transfer base, one or more augmenting ingredients and one or more recipient ingredients suitable for producing the completed food product; (b) placing the augmenting ingredients on the food transfer base to form an augmented base; (c) positioning the augmented base on, in or around the recipient ingredients to form an assembled food product; and (d) applying an external transformative step to the assembled food product to produce the completed food product and substantially integrate the food transfer base into at least one of the recipient ingredients and the augmenting ingredients. The transformative step will produce the completed food product and substantially change the character and/or consistency of the food transport base and the recipient ingredients. In one embodiment, the method further comprises the step of preparing the recipient ingredients, such as by baking, cooling or the like as necessary for the completed food product, prior to the positioning step.

The alteration of the recipient ingredients results in a re-classification (e.g., by name as recognized by a consumer) of the completed food product from one type of food product to another based on the various changes in ingredients, appearance, aroma, texture, quality, nutritional value and/or presentation of the recipient ingredients as a result of the addition of the food transfer base having the augmenting ingredients thereon. As will be readily appreciated by those skilled in the art, the present invention provides significant cooking convenience and reduction of time benefits, allows more consistent replication of recipes from one time to another and/or from a restaurant to the home and can reduce costs by allowing the toppings, inserts, seasonings or other augmenting ingredients to be prepared in more efficient batches with less waste.

Accordingly, one of the primary aspects of the present invention is to provide a device, system and method for preparing completed food products that has the advantages discussed above and which overcomes the disadvantages and limitations associated with presently available devices, systems and methods of preparing food products.

It is an important aspect of the present invention to provide an edible food transfer base that allows a food preparer to place one or more ingredients thereon and then quickly, easily and efficiently transfer those ingredients and the base to other ingredients when preparing a completed food product.

It is also an important aspect of the present invention to provide an edible food transfer base for transferring one or more augmenting ingredients to a recipient ingredient when preparing a completed food product without adding any unintended taste or other characteristics to the completed food product.

It is an important aspect of the present invention to provide an edible food transfer base that can be provided in a stiff, relatively rigid form for placing augmenting ingredients on or in a recipient ingredient or a flexible form for placing the augmenting ingredients around or over the recipient ingredient.

It is also an important aspect of the present invention to provide a system and method for preparing a completed food product that comprises having one or more augmenting ingredients on an edible food transfer base and then using the food transfer base to transfer the augmenting ingredients to one or more recipient ingredients to prepare a completed food product.

It is also an important aspect of the present invention to provide an edible food transfer base, a system comprising an edible food transfer base and a method of preparing a completed food product using a food transfer base having one or more augmenting ingredients thereon that are adaptable for a wide variety of ingredients and completed food products.

It is also an important aspect of the present invention to provide an edible food transfer base, a system comprising an edible food transfer base and a method of preparing a completed food product using a food transfer base having one or more augmenting ingredients thereon that significantly alters the recipient ingredients to produce the completed food product.

The above and other aspects and advantages of the present invention are explained in greater detail by reference to the attached figures and the description of the preferred embodiment which follows. As set forth herein, the present invention resides in the novel features of form, construction, mode of operation and combination of the above presently described and understood by the claims.

### BRIEF DESCRIPTION OF THE DRAWINGS

In the drawings which illustrate the preferred embodiments and the best modes presently contemplated for carrying out the present invention:

FIG. 1 is a side view of the components of a food transport base system showing an edible food transfer base receiving augmenting ingredients and then the transfer of the base and augmenting ingredients to a recipient ingredient to produce a completed food product;

FIG. 2 is a side view of augmenting ingredients on an edible food transfer base for placement on top of two recipient ingredients to prepare a completed food product;

FIG. 3 is a side view of an augment ingredient on an edible food transfer base being transferred onto a recipient ingredient to produce a completed food product;

FIG. 4 is a side view of augmenting ingredients on an edible food transfer base for placement inside recipient ingredients to prepare a completed food product;

FIG. 5 is a side view of a set of augmenting ingredients on an edible food transfer base;

FIG. 6 is a side view of an augmenting ingredient on a flexible, edible food transfer base;

FIG. 7 is a side view of the augmenting ingredient and flexible food transfer base of FIG. 6 shown wrapped around a recipient ingredient;

FIG. 8 is a side view of a completed food product that is produced after cooking the augmenting ingredient and recipient ingredient of FIG. 7 with the food transfer base thereof incorporated into the completed food product and, therefore, not shown; and

FIG. 9 is a schematic summary of a method of utilizing an edible food transfer base to transfer one or more augmenting ingredients to one or more recipient ingredients to prepare a completed food product.

### DETAILED DESCRIPTION OF THE PREFERRED EMBODIMENTS

With reference to the figures where like elements have been given like numerical designations to facilitate the reader's understanding of the present invention, the preferred embodiments of the present invention are set forth below. The enclosed text and drawings are merely illustrative of one or more preferred embodiments and, as such, disclose one or more different ways of configuring the present invention. Although specific components, materials, configurations and uses are illustrated, it should be understood that a number of variations to the components and to the configuration of those components described herein and in the accompanying figures can be made without changing the scope and function of the invention set forth herein. For instance, although the figures and description provided herein set forth certain examples of the food transfer base, augmenting ingredients, recipient ingredients and completed food products, those skilled in the art will readily understand that these examples are being provided for the purpose of explaining the present disclosure and that the present invention is not so limited.

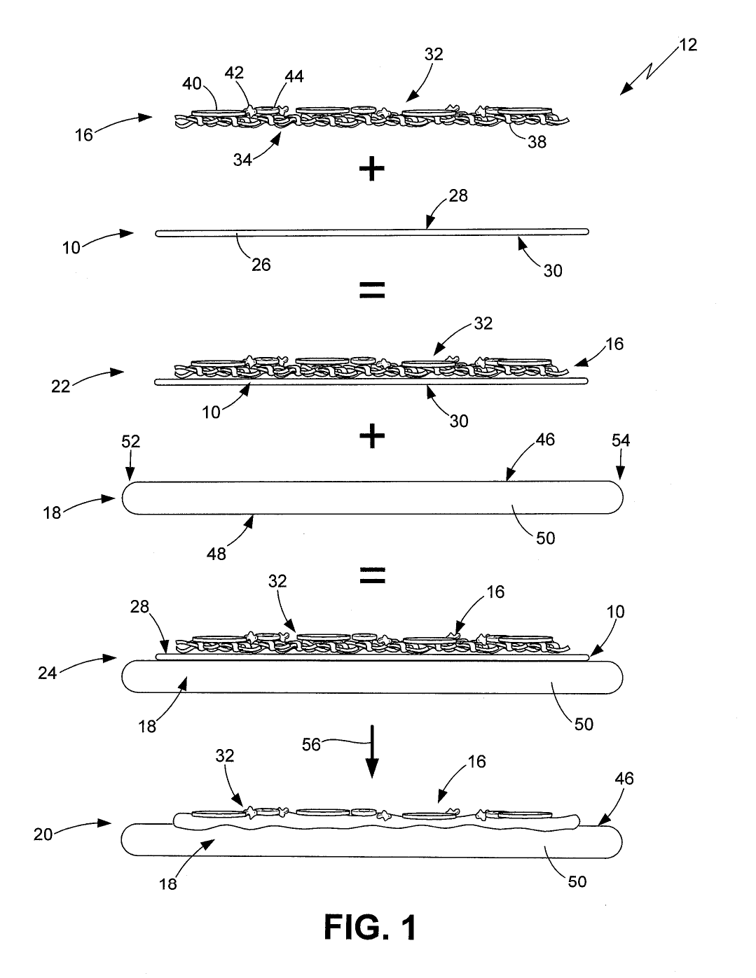

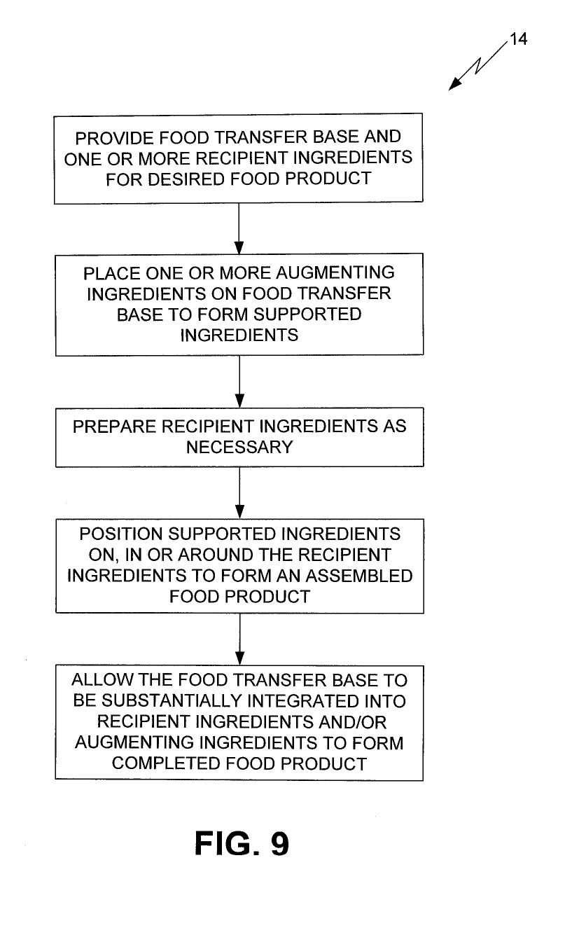

A food transfer base that is beneficially configured for use with one or more embodiments of the present invention is shown generally as 10 in the figures. A system comprising the food transfer base 10 is shown as 12 in FIGS. 1 through 4 and the summary of a method utilizing the food transfer base 10 is set forth as 14 in FIG. 9. As set forth in more detail below, food transfer base 10 of the present invention is utilized to transfer one or more food-related ingredients to one or more other ingredients, for the purpose of enhancing, modifying or otherwise augmenting the second ingredient(s) during the preparation of a food product that comprises the subject ingredients. For purposes of the present disclosure, the ingredient or ingredients being transferred by the food transfer base 10 are hereinafter referred to as augmenting ingredients 16, the ingredient or ingredients receiving the augmenting ingredients 16 are hereinafter referred to as the recipient ingredients 18 and the final, completed food product is hereinafter referred to as the completed food product 20. As will be more fully set forth in the discussion below and best shown in FIG. 1, augmenting ingredients 16 can be placed on or in the food transfer base 10 and then the combination of the food transfer base 10 and augmenting ingredients 16, referred to as the augmented base 22, are transferred to the recipient ingredients 18, resulting in the assembled food product 24 (a combination of food transfer base 10, augmenting ingredients 16 and recipient ingredients 18) so the food preparer may ultimately prepare the completed food product 20 for consumption by himself or herself and/or one or more other persons, collectively referred to as consumers. As will be readily appreciated from the discussion herein, application of the augmenting ingredients 16 to the recipient ingredients 18, by way of transfer base 10, significantly alters the characteristic of the recipient ingredients 18. Typically, this alteration results in a re-classification (e.g., by name as recognized by a consumer) of the completed food product 20 based on the change in ingredients, appearance, aroma, texture, quality, nutritional value and/or presentation of the recipient ingredients 18 as the completed food product 20 to the consumers.

The food transfer base 10 comprises a base body 26 having an upper surface 28 on which the augmenting ingredients 16 are typically placed and a lower surface 30 which is typically placed against the recipient ingredients 18. Alternatively, the augmenting ingredients 16 can be placed inside the base body 26 and/or the lower surface 30 of the base body 26 can be placed against a frying pan or other surface with the recipient ingredients 18 placed on top of the augmenting ingredients 16 or the upper surface 28. The augmenting ingredients 16 and food transfer base 10 define the augmented base 22, as shown in FIGS. 1 through 7. Neither food transfer base 10 nor augmented base 22 are intended, configured and/or selected for the purpose of being eaten alone. Instead, the purpose of the food transfer base 10 and augmented base 22 is to assist the food preparer with the transformation or alteration of the recipient ingredients 18 into the completed food product 20 that is to be eaten by the one or more consumers. In addition to being capable of transferring the augmenting ingredients 16 to the recipient ingredients 18, the food transfer base 10 is made up of materials or ingredients that provide it with the quality of being able to change character and/or consistency and be integrated with augmenting ingredients 16 and/or the recipient ingredient 18 with or without the additional application or activation by liquid, steam, gel, gas, heat, cold or other traditional or technological mechanisms that are used or which can be used to alter foods. The change in character or consistency of the food transfer base 10 can comprise: (a) dissolving into transparency or at least semi-transparency; (b) liquefying: (c) coagulating and/or gumming (e.g., gelatinizing); (d) thickening; (e) melting and expanding; (f) crisping or flaking; (g) foaming or effervescing; (h) toasting, browning or crumbling; or (I) bubbling or popping.

In any such manner, or other manners, of changing character and/or consistency for the food transfer base 10, the augmenting ingredients 16 will remain, partially or totally, in place on the recipient ingredients 18. The food transfer base 10, in conjunction with the augmenting ingredients 16, can be configured to transfer the augmenting ingredients 16 to the recipient ingredients 18 in virtually any material state, such as dry, frozen, refrigerated or etc. For example, food transfer base 10 can be provided in a dry state to receive various augmenting ingredients 16 thereon or therein and be configured to totally dissolve on/in and be transparent relative to the desired recipient ingredient 18 after being acted upon by heat that emanates from recipient ingredient 18 itself or by the application of heat from an external source, such as by being baked in a standard oven or cooked in a microwave oven. As such, the food transfer base 10 of the present invention combines two important aspects of preparing the completed food product 20, namely providing a medium to effectively, efficiently, easily and accurately transfer the augmenting ingredients 16 to recipient ingredient 18 and complimenting the desired texture, flavor, appearance and other features of the recipient ingredient 18 to obtain the completed food product 20. The use of food transfer base 10 to transfer augmenting ingredients 16 to a recipient ingredient 18 for the purpose of preparing completed food product 20 will save time, expense, energy, packaging (thereby reducing waste). Use of food transfer base 10 will also allow for unique recipe customization, uniformity of completed food product 20, incorporation of recipes from famous chefs and improved food production management.

The food transfer base 10 is made up of ingredients that render the food transfer base 10 edible so it can be safely eaten as part of the completed food product 20. For instance, the food transfer base 10 can be provided in a wafer configuration and made from tapioca, milk, rice, corn starch, sugar or guar gum that provides a virtually tasteless but easily dissolvable platform for transferring augmenting ingredients 16 to the recipient ingredients 18. Utilizing sugar and/or guar gum gives a sweet food transfer base 10 that can benefit completed food product 20. The food transfer base 10 can be stiff or rigid, configured to be breakable, cuttable, crushable, moldable or otherwise adaptable to being portion controlled or be flexible so it can be wrapped around a recipient ingredient 18. In one embodiment, base body 26 is made from tapioca, milk, rice, corn starch, sugar and/or guar gum, either singularly or in various combinations thereof. Alternatively, food transfer base 10 can be made from virtually any food or food-related product. For instance, the food transfer base 10 can be made from cheese, soya, sugar, pulverized olives, dried mashed potatoes, frozen peanut butter, egg whites, tomato paste and the like. If desired, the food transfer base 10 can be a single layer that has the augmenting ingredients 16 on the upper surface 28 of the base body 26 or be incorporated into the base body 26. Alternatively, the augmented base 22 can comprise multiple layers of the food transfer base 10 and the augmenting ingredients 16. In either configuration, the food transfer base 10 transfers augmenting ingredients 16 to the recipient ingredients 18 to, ultimately, result in completed food product 20. The food transfer base 10 can be made in virtually any size and shape and it can vary in thickness as necessary to support the various augmenting ingredients 16 that will be supported by food transfer base 10 and placed onto or inside the recipient ingredient 18. The thickness of the food transfer base 10 can also be selected so as to achieve the desired consistency on the recipient ingredient 18 desired for the completed food product 20. The types of materials for food transfer base 10 can be varied from one food transfer base 10 to another and even across the same food transfer base 10. For instance, a portion of a food transfer base 10 can be made with the addition of certain components (such as spices to make one section more spicy than the rest) or with less of certain components (such as using less salt on a portion for persons who desire to limit their salt intake). As will be readily appreciated to those skilled in the art, the variations possible from one food transport base 10 to another or across a single food transport base 10 are virtually unlimited.

The augmenting ingredients 16 will generally comprise a layer of various ingredients, defining an upper surface 32 and a lower surface 34, that are needed or desired for the completed food product 20, as best shown in FIG. 1. The lower surface 34 of the augmenting ingredients 16 will be placed against all or a portion of the upper surface 28 of the food transfer base 10 to define the augmented base 22, as best shown in FIGS. 1 and 5. With regard to FIG. 1, completed food product 20 is a pizza 36 (other example completed food products 20 are set forth below) that is made up of a variety of pizza-related ingredients. In the example pizza 36 of FIG. 1, the augmenting ingredients 16 comprise a cheese/sauce combination 38, pepperoni 40, sausage 42 and olives 44. The augmenting ingredients 16 are placed on the upper surface 28 of food transfer base 10 to define the augmented base 22. The bottom surface 30 of food transfer base 10 is placed against the upper surface 46 of the recipient ingredient 18, which also has a lower surface 48, to define the assembled ingredients 24. In the example pizza 36 of FIG. 1, recipient ingredient 18 is a layer of pizza dough 50, which may be in an uncooked or cooked condition. In this example, the augmenting ingredients 16 are configured to be totally supported by the food transfer base 10 and the food transfer base 10 is sized to fit between the first end 52 and second end 54 (looking at it from the side view) of the recipient ingredient 18 (pizza dough 50). In other examples, the food transfer base 10 and/or the augmenting ingredients 16 may not be sized to fit within ends 52/54 of the recipient ingredient 18. As will be readily appreciated by those skilled in the art, the assembled ingredients 24 will undergo a transformative step, shown as 56 in FIG. 1 that transforms the assembled ingredients 24 into completed food product 20 and the base body 26 of food transfer base 10 will substantially change character and/or consistency, as set forth above. Typically, the transformative step 56 for pizza 36 will comprise heating the assembled ingredients 24 by cooking or other appropriate means or, if the pizza dough 50 is already cooked, melting the augmented base 22 due to the heat of the pizza dough 50. In either type of transformation, the food transfer base 10 will dissolve or otherwise effectively “disappear” as a separate component by being incorporated into the augmenting ingredients 16 and/or the recipient ingredients 18. As will be readily appreciated by those skilled in the art, application of the augmented base 22, which comprises the augmenting ingredients 16 and food transfer base 10, to the recipient ingredients 18 significantly alters the characteristic (i.e., changing it from plain pizza dough 50 to a pizza 36) of the recipient ingredients 18.

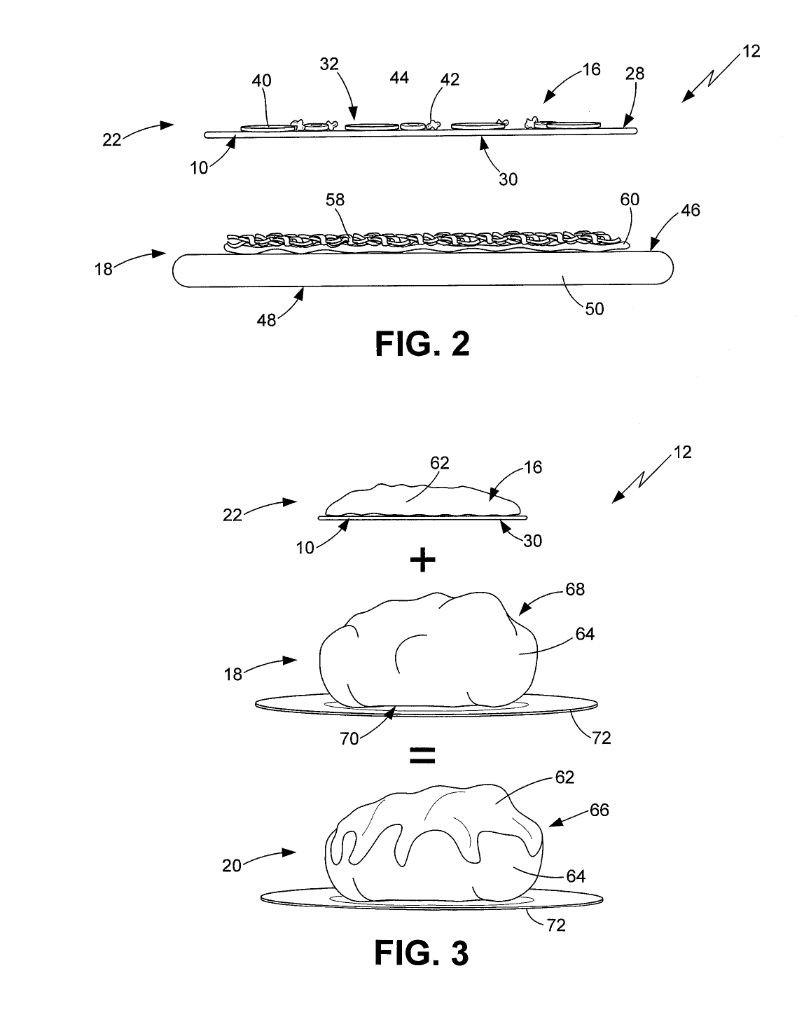

A slightly different example of the use of food transfer base 10 to achieve a pizza 36 as the completed food product 20 is shown in FIG. 2. In this embodiment, certain augmenting ingredients 16 are included on the food transfer base 10 and other ingredients that benefit the completed food product 20 are included with the recipient ingredients 18. In FIG. 2, the pepperoni 40, sausage 42 and olives 44 are included on the food transfer base 10, but the cheese 58 and pizza sauce 60 are included on the pizza dough 50. In one use of this type of embodiment, the manufacturer or other supplier can provide a single or generic pizza dough 50 having cheese 58 and pizza sauce 60 on the upper surface 46 and also supply a wide variety of prepared augmented bases 22 that have different augmenting ingredients 16 thereon (such as bacon/mushroom/onions, vegetarian or Canadian bacon/pineapple), thereby providing consumers with a wide variety of choices of pizza toppings without having to package the entire pizza 36 for each of those varieties. The recipient ingredients 18 can also be varied by the type of pizza dough 50, cheese 58 and/or pizza sauce 60 to allow additional consumer choices. The consumer selects the recipient ingredients 18 and augmented base 22 of his or her choice to have a pizza 36 which is desirable to him or her without being limited to the few choices typically available for present day consumers.

FIG. 3 shows a food transfer base system 12 comprising food transfer base 10 having a sauce or gravy 62 on food transfer base 10, defining the augmented base 22, that is utilized to significantly alter the recipient ingredient 18, which in this example is mashed potatoes 64. Typically, for this embodiment the food transfer base 10 and the sauce or gravy 62 will be provided frozen or at least gel-like refrigerated state. A wide variety of sauces or gravies 62 and mashed potatoes 64 or like foods can be utilized to produce completed food product 20, which in the embodiment of FIG. 3 is mashed potatoes/gravy 66. The lower surface 30 of the base body 26 is placed on the top surface 68 of the mashed potatoes 64 (with the bottom surface 70 thereof shown on a plate 72). In one use of this embodiment, the mashed potatoes 64 are hot and the placement of the augmented base 22 thereon will melt the gravy 62 over the mashed potatoes 64. In another use of this embodiment, the augmented base 22 can be placed separately in an oven, microwave oven or other heating device to melt the gravy 62 prior to placement on the mashed potatoes 64. Alternatively, gravy 62 (while on food transfer base 10) and the mashed potatoes 64 can be heated together in a heating device to produce the mashed potatoes and gravy 66 of the completed food product 20. Many other similarly configured completed food products 20 can be prepared in much the same way as described above.

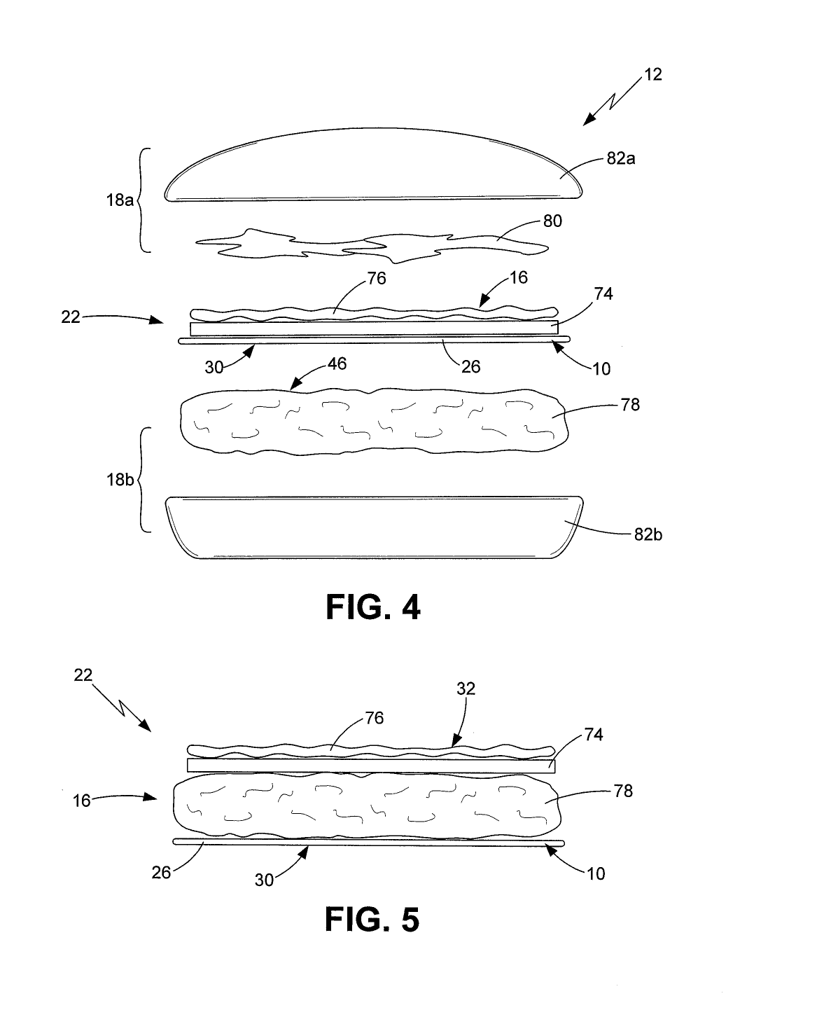

The embodiment of FIG. 4 shows the placement of augmenting ingredients 16, disposed on food transport base 10 and forming the support ingredients 22, inside the recipient ingredients 18. In this embodiment, the completed food product 20 is a cheeseburger. In FIG. 4, augmenting ingredients 16 comprise a slice of cheese 74 and a hamburger sauce 76 and the recipient ingredients 18 comprise a hamburger patty 78, lettuce 80 and a hamburger bun (shown in two halves, a top half 82a and a bottom half 82b). Recipient ingredient 18 is divided into an upper recipient ingredient 18a and a lower recipient ingredient 18b, with upper recipient ingredient 18a including the lettuce 80 and the top half 82a of the hamburger bun and the lower recipient ingredient 18b including the hamburger patty 78 and the bottom half 82b of the hamburger bun. As with the mashed potatoes/gravy 66 described above, augmented base 22 can be provided frozen or refrigerated and then warmed up by placement on a hot hamburger patty 78 or the augmented base 22 can be placed on the hamburger patty 78 and the items warmed up together in a heating apparatus such as a standard oven or microwave oven. An alternative embodiment for a cheeseburger as the completed food product 20 is shown in FIG. 5. In this embodiment, hamburger patty 78 is also included in the augmented base 22 with the slice of cheese 74 and hamburger sauce 76 on the food transport base 10, requiring the consumer to add only the lettuce 80, top half 82a of the bun and the bottom half 82b of the bun to prepare his or her cheeseburger. The hamburger sauce 76 for either of these embodiments, or like embodiments, can be a specially formulated or “secret” sauce prepared by a famous chef or a company that is known for its hamburgers and hamburger sauce 76. In this manner, the food preparer and/or consumer can have the special hamburger sauce 76 without having to spend the time and effort to produce their own to the, presumably, exacting recipe required for the special hamburger sauce 76. As will be readily apparent to those skilled in the art, a wide variety of different meats (e.g., for non-hamburger products), cheeses, condiments, sauces and other ingredients can be utilized in the present example to achieve the completed food product 20 desired by the consumer thereof.

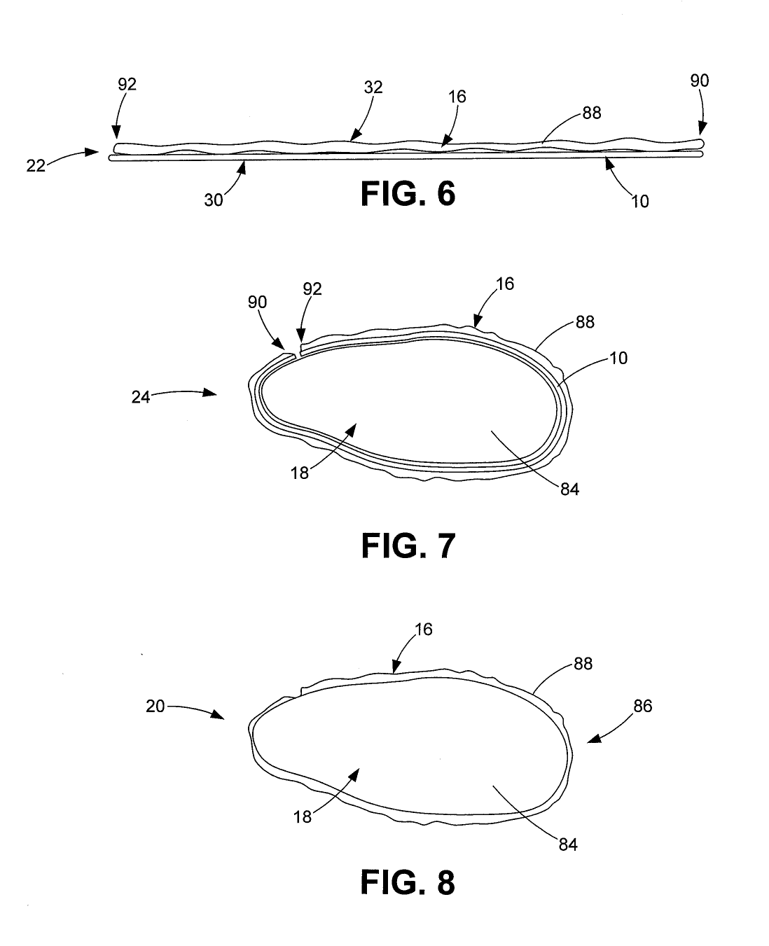

An example of an augmented base 22, comprising food transfer base 10 and augmenting ingredients 16, that is configured with a flexible food transfer base 10 that can wrap around a recipient ingredient 18 is shown in FIGS. 6, 7 and 8. In one use of this embodiment, recipient ingredient 18 is a piece of chicken 84 that is desired to be covered with various spices and other materials to form a baked chicken product, shown as 86 in FIG. 8, as the completed food product 20. The flexible food transfer base 10 is shown in FIG. 6 as substantially covered with augmenting ingredients 16 comprising a variety of spices and other materials that are selected to form the desired covering, shown as 88 in FIGS. 6 through 8, for the baked chicken product 86. In this embodiment, the augmented base 22, having a first end 90 and a second end 92, are wrapped around the piece of chicken 84, as shown in FIG. 7, and then assembled food product 24 is placed in an oven, microwave oven or other heating apparatus to produce the baked chicken product 86. Many other food items can be prepared in a similar manner utilizing a flexible food transfer base 10 to wrap around and/or over the recipient ingredient 18.

In addition to actual food items such as cheese/sauce 38, pepperoni 40, sausage 42, olive 44, hamburger patty 78, lettuce 80 and the like, augmenting ingredients 16 can comprise herbs, flavorings, seasonings, starches, proteins, fats, oils, nutrients, phyto-nutrients, gases, vitamins, minerals, medications, gums, adherents, colorings, coatings, preservatives, fibers and any other edible ingredients, as desired by the food preparer, consumers and/or others.

A method 14 of using the food transfer base 10 described above is summarized in FIG. 9. Initially, a food transfer base 10 is selected having the characteristics described herein for the type of completed food product 20 that the food preparer desires to prepare. Likewise, the food preparer or someone on his or her behalf will select and, as necessary, collect one or more augmenting ingredients 16 and one or more recipient ingredients 18. In some circumstances the same person will select the food transfer base 10, augmenting ingredients 16 and recipient ingredients 18. In other circumstances, the food transfer base 10 and augmenting ingredients 16 will be selected (and as set forth below, prepared) by one person or entity, such as a frozen food provider, and a second person will select and prepare recipient ingredients 18, such as the consumer/food preparer. The augmenting ingredients 16 are placed on food transfer base 10, thereby forming the augmented base 22, in a manner that is consistent with what is desired for the completed food product 20, which may involve evenly placing the augmenting ingredients 16 across food transfer base 10 or placing augmenting ingredients 16 in a non-uniform (e.g., not evenly spaced) across the food transfer base 10. The recipient ingredients 18 are prepared as necessary to receive the augmented base 22. This may involve baking the recipient ingredients 18, such as the pizza dough 50, or otherwise warming up the recipient ingredients 18 so the food transfer base 10 will dissolve and the augmenting ingredients 16 will melt thereon. Other recipient ingredients 18, such as the hamburger patty 78, will be prepared by being cooked (e.g., barbequed) prior to placement of augmented base 22 on the recipient ingredients 18. Once the recipient ingredients 18 are ready for the augmenting ingredients 16, the augmented base 22 are positioned on, in or around the recipient ingredients 18 as necessary to achieve assembled food product 24. The assembled food product 24 will become the completed food product 20 through the application of a transformative step 56 that incorporates food transfer base 10 into augmenting ingredients 16 and/or recipient ingredients 18 and, as applicable, incorporates the augmenting ingredients 16 into recipient ingredients 18. In some circumstances, heat or other temperature input from the previously prepared recipient ingredients 18 will dissolve food transfer base 10 and melt augmenting ingredients 16. In other circumstances, augmented base 22 and recipient ingredients 18 will be heated in an oven, microwave oven or other heating apparatus to jointly cook the all of the ingredients and form the completed food product 20.

The food transfer base 10 can be prepared or manufactured with multiple vertical layers within the same food transfer base 10 with the different layers having different qualities upon contact with the recipient ingredients 18 and/or application of steam, liquid, gel, gas, heat, cold or other means of altering foods that, in effect, activates the food transfer base 10. In one example use, a bottom layer can dissolve and a top layer can crisp. Augmenting ingredients 16, which may be food, spices or any of the other items described above, can be suspended or otherwise placed between the layers of food transfer base 10. In addition to vertical layers, the food transfer base 10 can be provided with multiple horizontal “layers” across the upper surface 28 of the base body 26 of the food transfer base 10 or between multiple layers of a single food transfer base 10. For instance, utilizing the example of a pizza as the completed food product 20, the augmented base 22 can comprise different combination of augmenting ingredients 16 in each of the four different quadrants of a single food transfer base 10. With these augmented bases 22, a food preparer, whether at a restaurant or home-based, can start with a basic large cheese pizza (having pizza dough 50, cheese 58 and sauce 60 as shown in FIG. 2) and easily, efficiently and relatively inexpensively create a multiple topping pizza. Likewise, other types of completed food products 20 can be embellished with different augmenting ingredients 16 across, in or over the recipient ingredient 18.

Even when a food transfer base 10 has only a single augmenting ingredient 16 or a limited combination of augmenting ingredients 16, the food preparer can create a custom completed food product 20 by combining multiple food transfer bases 10, each with their own set of augmenting ingredients 16, with a recipient ingredient 18. For instance, a combination pizza can be created by starting with a basic cheese pizza (as described above) and adding one food transfer base 10 with pepperoni as the augmenting ingredients 16, another food transfer base 10 with sausage and olives as the augmenting ingredients 16, another food transfer base 10 with onions, bell peppers and mushrooms as the augmenting ingredients 16 and a top or last food transfer base 10 having extra cheese as the augmenting ingredients 16. The type of completed food product 20 can be varied, such that multiple food transfer bases 10 each with various augmenting ingredients 16 can be utilized with virtually any recipient ingredients 18 to create any type of food product. For instance, the recipient ingredients 18 can comprise a basic salad and an addition to the basic salad can include diced onions and tomatoes, as the augmenting ingredients 16, on a basil-flavored food transfer base 10 with a second addition to the basic salad of chicken strips and a fat-free Italian dressing on another transfer base 10 to top the salad (recipient ingredient 18). In one embodiment, the food transport bases 10 can be selected such that the application of water, such as by spraying, will dissolve the two food transfer bases 10 and combine the augmenting ingredients 16 with the recipient ingredient 18 to create a flavorful, healthy salad. Utilizing multiple food transfer bases 10 having augmenting ingredients 16 thereon on any “plain” recipient ingredient 18, such as a basic baked potato, cooked noodles, vegetables, bread products and the like, will allow the food preparer to quickly and easily create a healthy, tasty and appealing meal. Naturally, any combination of multiple food transfer bases 10 and augmenting ingredients 16 can be utilized with virtually any type of recipient ingredients 18, whether healthy or not, to create any number of completed food products 20.

As set forth above, use of the food transport base system 12 and method 14 allows virtually any food preparer to easily, efficiently and usually less expensively change one category of food to another. For instance, green beans (as the recipient ingredient 18) can be changed into a sausage, mushroom green bean casserole by topping the green beans with a food transfer base 10 having a sausage mushroom gravy as the augmenting ingredients 16. Likewise, a steak can become a Salisbury-Peppercorn steak by topping it with a food transfer base 10 having appropriately selected augmenting ingredients 16. In addition, a food preparer can use a single combination of food transfer base 10 and augmenting ingredients 16 with different recipient ingredients 18 to create different completed food products 20. As an example, lasagna cheese and beef (as the augmenting ingredients 16) on a savory tomato flavored food transfer base 10 can be utilized with recipient ingredients 18 such as lasagna noodles, placed between layers of French bread and baked into a savory sandwich or placed on top of grilled sourdough bread as a bruschetta appetizer. As another example, food transfer base 10 can be a dry, sweet wafer film imbedded with an effervescent vanilla, powdered cream with caramel swirl (as the augmenting ingredients 16) that will foam on contact with hot liquid coffee, as the recipient ingredients 18, to create a decorative “latte” effect or it can be a flavoring that melts when place on hot bread pudding.

The food transfer base 10, system 12 and method 14 of the present invention also provides significant flexibility for the food preparer and those who will consume the completed food product 20. A flavored food transfer base 10 can be utilized as a garnish at the point of serving the food product 20 to the consumers or it can be utilized as a thickening agent to thicken and flavor soups and stews. The present invention can also be utilized to provide serving size control for single or multiple serving options. For instance, a food transfer base 10 having a beef gravy as the augmenting ingredients 16 can be placed on hot mashed potatoes (the recipient ingredient 18) as an instant gravy. For a large family serving, the entire food transfer base 10 can be used over a large batch of mashed potatoes 18. For an individual serving, the food preparer or consumer can tear off a portion of food transfer base 10, having some of the augmenting ingredients 16 thereon, and place it on his or her own serving of mashed potatoes 18 in the desired quantity. In addition, use of the present invention will allow each family member to select their own flavor of gravy by utilizing different food transfer bases 10 each with their own augmenting ingredients 16 (such as beef, turkey or sausage gravy) or a single food transfer base 10 having different augmenting ingredients 16 thereon.

The food transfer base 10, system 12 and method 14 of the present invention can also be utilized to assist in portion control and weight management for dieters by utilizing augmenting ingredients 16 that have precise measure and caloric units suitable for achieving the consumer's dieting goal. In addition, the combined food transfer base 10 and augmenting ingredients 16, the augmented base 22, can have precisely measured amounts of fiber, sodium, sugar and other materials to allow the consumer to control his or her intake of such items to provide the health maintenance/improvement objectives he or she desires. If desired, augmented base 22 can also include vitamins and/or medications that are required or beneficial for the consumers of the completed food product 20. With regard to children as the consumers, use of such a food product to deliver vitamins and/or medications may enable the parent or other caregiver to provide these materials to the child in a manner that is much more palatable to the child and, as a result, much more likely to be “taken” and, therefore, benefit the child. The present invention can also be utilized to control or avoid allergy problems for consumers who have allergic conditions with regard to certain foods, with the augmenting ingredients 16 being selected so as to avoid such issues.

As stated above, the present invention provides significant cooking convenience and reduction of time benefits, allows more consistent replication of recipes from one time to another and/or from a restaurant to the home and can reduce costs by allowing the toppings, inserts, seasonings or other augmenting ingredients 16 to be prepared in more efficient batches. The food transfer base 10 having augmenting ingredients 16 thereon can be placed first in a pan or other cooking device and then the meat, vegetables or other recipient ingredients 18 added on top of the first food transfer base 10 and its augmenting ingredients 16. A second food transfer base 10 having, as desired, the same or a different set of augmenting ingredients 16 can be placed on top of the recipient ingredients 18. Use of the same augmenting ingredients 16 can be beneficial in obtaining a more uniform dispersal of the spices and other items therein so that the flavor of the completed food product 20 is more consistent from one piece to another. The present invention can also improve efficiency and safety by reducing the number of bottles, jars and/or cans the food preparer would otherwise have to handle while preparing a food product 20 having multiple spices and other ingredients. By including these as augmenting ingredients 16 on a food transfer base 10, the food preparer only has to handle the one item to place the desired augmenting ingredients 16 on the recipient ingredients 18. Use of the present invention also provides food handling safety benefits by reducing or even eliminating the need for the food preparer to touch recipient ingredients 18. In addition, the present invention reduces the likelihood of cross-contamination among food products that commonly occurs when the food preparer, typically by handling various bottles of spices and the like, seasons or otherwise prepares different types of foods, particularly fowl, meat or seafood. Normally, as the food preparer opens and shakes spices or other materials onto the food and handles the food he or she will contaminate a food product with previously handled food products, unless the bottles or other containers are adequately cleaned between preparation of food products. The present invention reduces or eliminates the need for the food preparer to handle a variety of different bottles or other containers of spices and/or other augmenting ingredients 16.

The augmented base 22 can be packaged in convenient to store and use packages in a dried, frozen, dehydrated, refrigerated or other condition, as appropriate for food transfer base 10 and augmenting ingredients 16. As stated above, the present invention also saves money by reducing the need to have many separate augmenting ingredients 16 available when they are needed. As well known, often a product gets slightly utilized and then the rest is discarded because the product has spoiled or exceeded its desired use-by date. In addition, the food preparer does not have to maintain ingredients that have different expiration dates. For instance, a garnish for hot chocolate comprising whip cream and chocolate sauce (the augmenting ingredients 16) can be placed on an appropriate food transfer base 10 and applied to the hot chocolate when desired, eliminating the need to separately store refrigerated whip cream and a container of chocolate sauce. Use of the present invention can avoid the waste associated with having to discard ingredients and eliminate potential food poisoning issues that can result from serving food made from ingredients that have spoiled or otherwise gone bad, both of which are of particular concern with regard serving food at restaurants and other eating establishments where such incidents can destroy the business.

The food transfer base 10, system 12 and method 14 of the present invention is also beneficial for “on-the-go” meals due to the convenience and ease of preparing the completed food product 20. In addition, the recipient ingredients 18 can be kept separate from the augmenting ingredients 16 until the consumer is ready to eat, which is particularly beneficial for keeping breads and some other food items fresh and not soggy. For a quick sandwich, augmenting ingredients 16 can be added to the bread (recipient ingredient 18) and then heated in a microwave oven to have a hot, tasty meal. The present invention also reduces the possibility of food illnesses from poor temperature control or handling of ingredients.

The present invention also facilitates the food preparer creating new variations of old recipes by placing different augmenting ingredients 16 on, in or over the food product of the “old” recipe. For instance, the food preparer can create oven roasted meatballs with a crispy, but not hard, exterior texture by applying an appropriately selected combination of food transfer base 10 and augmenting ingredients 16. The present invention can also help restaurants and the like by allowing the establishment to offer many different variations of the same basic dish, such as chicken or a particular cut of beef. By utilizing the food transfer base 10, system 12 and method 14 of the present invention, the food preparer can inexpensively and efficiently offer the consumer many different choices, essentially allowing the consumer to choose to have the food product prepared his or her way. In addition, plain foods can be exotic and, likely, seem more desirable. For instance, a plain biscuit can become savory with the addition of sage and Parmesan cheese or sweet with the addition of a butter-toffee mix, either of which can be applied to the biscuit with a food transfer base 10 having the appropriate augmenting ingredients thereon. In another embodiment, the system 12 and method 14 can be customized for a particular industry, such as bakeries, with a variety of augmented bases 22 being available to bakeries so they can quickly, easily and relatively inexpensively create certain types of baked deserts, such as those for holidays, birthdays and other special occasions.

The food transfer base 10, system 12 and method 14 of the present invention provide an accurate, efficient, convenient, safe and money-saving mechanism to alter a recipient ingredient 18, including an existing food or drink, at any stage in the production of a completed food product 20, including during manufacture, distribution, retail, food service and end-user (consumer) stages. In one manner of use, the food transport base system 12 of the present invention can be utilized by food manufacturers, chefs and consumers (as the food preparer) to transfer a group of food items, as the augmenting ingredients 16, to any other food item, as the recipient ingredients 18, in a single step. As such, avoiding the effort, time and expense that would otherwise be associated with preparing the completed food product 20. The use of food transfer base 10 to transfer various augmenting ingredients 16 to a recipient ingredient 18 for the purpose of preparing completed food product 20 will save time, expense, energy, packaging (thereby reducing waste). Use of food transfer base 10 also allows for unique recipe customization, uniformity of the completed food product 20 from one time or portion to another, incorporation of recipes from famous chefs and improved food production management. In addition, the use of the present invention, will allow for significant enhancement of otherwise plain foods to make the foods more tasty, appealing and desirable.

While there are shown and described herein a specific form of the invention, it will be readily apparent to those skilled in the art that the invention is not so limited, but is susceptible to various modifications and rearrangements in design and materials without departing from the spirit and scope of the invention. In particular, it should be noted that the present invention is subject to modification with regard to any dimensional relationships set forth herein and modifications in assembly, materials, size, shape and use. For instance, there are numerous components described herein that can be replaced with equivalent functioning components to accomplish the objectives of the present invention.

What is claimed is:

1. A food transfer base, comprising:
a base body having an upper surface and a lower surface, said base body made from an edible material that is not selected to be eaten alone, said food transfer base configured for receiving one or more augmenting ingredients on or in said base body so as to define an augmented base, said augmented base not selected to be eaten alone, said augmented base configured to be received against or in one or more recipient ingredients, said edible material of said base body selected to be integrated into at least one of said augmenting ingredients and said recipient ingredients upon contact with said recipient ingredients or application of an external transformative step to produce a completed food product wherein said base body and said recipient ingredients substantially change character and/or consistency.

2. The food transfer base of claim 1, wherein said base body is flexible.

3. The food transfer base of claim 1, wherein said base body substantially dissolves upon contact with said recipient ingredients or application of said external transformative step.

4. The food transfer base of claim 3, wherein said base body becomes transparent or at least semi-transparent upon contact with said recipient ingredients or application of said external transformative step.

5. The food transfer base of claim 1, wherein said base body substantially liquefies upon contact with said recipient ingredients or application of said external transformative step.

6. The food transfer base of claim 1, wherein said base body substantially coagulates, gums and/or thickens upon contact with said recipient ingredients or application of said external transformative step.

7. The food transfer base of claim 1, wherein said base body substantially melts, crisps, toasts, browns or crumbles upon contact with said recipient ingredients or application of said external transformative step.

8. The food transfer base of claim 1, wherein said base body substantially foams, effervescents, bubbles or pops upon contact with said recipient ingredients or application of said external transformative step.

9. A system for producing a completed food product, said system comprising:
a food transfer base having a base body with an upper surface and a lower surface, said base body made from an edible material that is not selected to be eaten alone;
one or more augmenting ingredients received on said upper surface of said base body to define an augmented base, said augmented base not selected to be eaten alone; and
one or more recipient ingredients,
wherein said augmented base is configured to be placed on, in or around said recipient ingredients to define an assembled food product and said edible material is selected so as to be integrated into at least one of said augmenting ingredients and said recipient ingredients upon contact with said recipient ingredients or application of an external transformative step to produce a completed food product wherein said base body and said recipient ingredients substantially change character and/or consistency.

10. The system of claim 9, wherein said base body is flexible.

11. The system of claim 9, wherein said base body substantially dissolves upon contact with said recipient ingredients or application of said external transformative step.

12. The system of claim 11, wherein said base body becomes transparent or at least semi-transparent upon contact with said recipient ingredients or application of said external transformative step.

13. The system of claim 9, wherein said base body substantially liquefies upon contact with said recipient ingredients or application of said external transformative step.

14. The system of claim 9, wherein said base body substantially coagulates, gums and/or thickens upon contact with said recipient ingredients or application of said external transformative step.

15. The system of claim 9, wherein said base body substantially melts, crisps, toasts, browns or crumbles upon contact with said recipient ingredients or application of said external transformative step.

16. The system of claim 9, wherein said base body substantially foams, effervesces, bubbles or pops upon contact with said recipient ingredients or application of said external transformative step.

17. A method of producing a completed food product, said method comprising the steps of:
a) providing a food transfer base, one or more augmenting ingredients and one or more recipient ingredients suitable for producing said completed food product;
b) placing said one or more augmenting ingredients on said food transfer base to form an augmented base;
c) positioning said augmented base on, in or around said recipient ingredients to form an assembled food product; and
d) applying a transformative step to said assembled food product to produce said completed food product and substantially integrate said food transfer base into at least one of said recipient ingredients and said augmenting ingredients, said transformative step substantially changing the character and/or consistency of said food transport base and said recipient ingredients.

18. The method of claim 17 further comprising the step of preparing said recipient ingredients as necessary for said completed food product prior to said positioning step.

19. The method of claim 17, wherein said food transfer base substantially dissolves, liquefies, coagulates, thickens, melts, crisps, flakes, foams, effervesces, toasts, browns, crumbles, bubbles and/or pops upon contact with said recipient ingredients or application of said external transformative step.

20. The method of claim 19, wherein said base body becomes transparent or at least semi-transparent upon contact with said recipient ingredients or application of said external transformative step.
